(19) United States
(12) Patent Application Publication
(10) Pub. No.: US 2010/0212803 A1
(43) Pub. Date: Aug. 26, 2010

(54) SYSTEMS AND METHODS OF REINFORCING A PIPE USING FIBER BUNDLES

(76) Inventors: Heath Carr, Encinitas, CA (US); Edward Fyfe, Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/709,388

(22) Filed: Feb. 19, 2010

Related U.S. Application Data
(60) Provisional application No. 61/154,315, filed on Feb. 20, 2009.

(51) Int. Cl. B32B 37/16; B32B 37/00

(52) U.S. Cl. 156/60; 156/361

(57) ABSTRACT

A method of reinforcing a pipe or other structure using fiber reinforced polymer includes coating a raw carbon and/or other types of fiber roving with an epoxy or other resin, selectively directing the fiber roving through a positioning assembly of a reinforcing system, splaying the fiber roving that exits the positioning assembly onto a pipe wall or other surface, rotating the positioning assembly about an axis to place splayed fiber roving along a first circumferential section of the pipe wall or other surface and moving the positioning assembly along a longitudinal axis of the pipe or other structure to selectively place splayed fiber roving along a second circumferential section of the wall.

### CROSS REFERENCE TO RELATED APPLICATIONS

This application claims the priority benefit under 35 U.S.C. §119(e) of U.S. Provisional Patent Application No. 61/154,315, filed Feb. 20, 2009, the entirety of which is hereby incorporated by reference herein.

### BACKGROUND

1. Field of the Inventions

This application relates generally to devices, systems and methods for reinforcing pipes and other structures, and more specifically, to devices, systems and methods for reinforcing the interior of pipes using fiber reinforced polymer.

2. Description of the Related Art

Over time or because of a particular event or condition (e.g., seismic activity, exposure to excessive or uneven loads or moments, poor compaction, crown corrosion, corrosive soil, etc.), the structural integrity or capacity of force mains, other pipes and other structures may diminish. For example, such items may crack, corrode, deteriorate and the like. Different methods of repairing or otherwise strengthening damaged pipes and other items are well-known. For example, liners or sheets can be attached to one or more portions of a pipe interior. Typically, such liners or sheets must be pre-manufactured and transported to a job site. In addition, these liners and sheets are often hand applied, making their installation labor consuming and expensive. Thus, there remains a need for a more efficient and cost-effective method of reinforcing pipes and other structures using fiber materials, such as, carbon fiber reinforced polymer.

### SUMMARY

According to some embodiments, a system for reinforcing a pipe comprises a resin source comprising a resin (e.g., epoxy) such that the resin source is configured to at least partially impregnate or saturate a fiber bundle with resin. In one embodiment, the system is configured to at least partially impregnate or saturate a raw fiber bundle or roving being moved through the system with the resin. The system additionally includes a positioning assembly configured to receive a resin-impregnated fiber bundle. In some embodiments, the positioning assembly comprises one or more arms, each of which includes a distal end. In certain arrangements, the system is configured to selectively advance the resin-impregnated fiber bundle relative to the positioning assembly, toward the distal end of the at least one arm. The system further comprises at least one spreading member (or applicator assembly or head) extending from the at least one arm, wherein the spreading member is configured to spread the resin-impregnated fiber bundle from a first width to a second width and onto an interior wall of the pipe. In one embodiment, the second width of the resin-impregnated fiber bundle is greater than the first width. In some embodiments, the system additionally includes a controller for regulating one or more aspects related to the manner in which the resin-impregnated fiber bundle is advanced relative to the positioning assembly and to the spreading member toward and onto the interior wall of the pipe. In several embodiments, resin-impregnated fiber bundle splayed by the spreading member is configured to directly adhere to the interior wall of the pipe without the use of tack coats or other intermediate layers.

According to some embodiments, the positioning assembly is configured to be grasped and manually manipulated by a user. In other embodiments, the positioning assembly is configured to be automatically moved relative to the interior wall of the pipe. In one embodiment, the positioning assembly is configured to selectively rotate about a longitudinal axis of the pipe to circumferentially place resin-impregnated fiber bundle along the interior wall of the pipe. In some embodiments, the fiber bundle comprises a carbon fiber bundle. In other embodiments, the resin source is generally positioned between a raw fiber bundle source and the positioning assembly. In another embodiment, the resin source comprises at least one advancement assembly (e.g., roller, roller assembly, etc.) to help direct raw fiber bundle from the raw fiber bundle source relative to said resin source to at least partially impregnate said raw fiber bundle with resin. In certain arrangements, the raw fiber bundle source, the resin source and the positioning assembly are positioned on a movable assembly, such as a robotic assembly (e.g., completely or partially automated), said movable assembly being configured to be automatically or manually moved within an interior of the pipe. According to some embodiments, the movable assembly comprises a wheeled cart. In one embodiment, the movable assembly comprises a foot pedal configured to selectively move said movable assembly within the interior of the pipe. In some embodiments, the at least one advancement assembly comprises a roller.

According to certain embodiments, the system comprises at least one advancement assembly configured to selectively advance the resin-impregnated fiber bundle toward the spreading member. In some arrangements, the at least one advancement assembly comprises a roller. In one embodiment, the controller comprises a handheld device (e.g., either attached to the positioning assembly or separate from it) configured to be selectively operated by a user. In some embodiments, the controller comprises one or more buttons (dials, switches or other controllers) positioned on the positioning assembly. In some embodiments, the handheld device is configured to selectively operate at least one roller assembly adapted to selectively advance the resin-impregnated fiber bundle toward the distal end of the positioning assembly.

According to some embodiments, the positioning assembly comprises at least one joint, which is configured to permit a user to modify an angle at which a resin-impregnated fiber bundle is placed on the interior wall of the pipe. In some embodiments, the controller is configured to selectively regulate the movement of the positioning assembly about the longitudinal axis of the pipe. In another embodiment, the positioning assembly is configured to be moved longitudinally within the pipe so as to coat a desired longitudinal section of the interior wall of the pipe with resin-impregnated fiber bundle. In some embodiments, the controller is configured to control a longitudinal movement of the positioning assembly within the pipe. In another embodiment, the positioning assembly is secured to a support member, wherein the support member includes a first leg and at least a second leg such that the first and second legs are configured to contact the interior wall of the pipe. In another embodiment, the support member is configured to be moved longitudinally within an interior of the pipe. In some embodiments, the support member comprises a wheeled cart, a tripod or some other movable cart or member (e.g., wheeled cart). In one embodiment, the fiber bundle is provided on a spool or in a bulk container. In some embodiments, the fiber bundle comprises nylon, glass, graphite, polyaramid and/or other materials. In some embodiments, the resin comprises epoxy, polyurethane, acrylic or other polymers with favorable cohesive strength characteristics. In one embodiment, the positioning assembly comprises two or more spreading members so as to allow two coats of resin-impregnated fiber bundle to be applied to the interior wall of the pipe.

According to some embodiments, a method of reinforcing a concrete surface (e.g., an interior or exterior of a pipe, a wall, a beam, a column, a slab, etc.) using fiber reinforced polymer includes coating a raw fiber roving with a resin (e.g., epoxy), selectively directing the resin-coated fiber roving through a positioning assembly of a reinforcing system, spreading the resin-coated fiber roving that exits a distal end of the positioning assembly onto a pipe wall, rotating the positioning assembly about an axis to place resin-coated fiber roving along a first circumferential section of the pipe wall and moving the positioning assembly along a longitudinal axis of the pipe to selectively place resin-coated fiber roving along a second circumferential section of the pipe wall.

In other embodiments, the method additionally includes the step of providing a primer or tack coat or any other liner or coating on the concrete surface (e.g., interior wall of a pipe) prior to spreading the resin-coated fiber roving onto the concrete surface. In some embodiments, the method additionally comprises providing at least one top coat over the spread fiber roving that is positioned on the pipe wall. In other arrangements, the step of selectively directing the fiber roving through the positioning assembly comprises operating one or more advancement assemblies of the positioning assembly. In another embodiment, the at least one advancement assembly comprises one or more rollers, roller assemblies and/or the like. In one embodiment, the step of spreading the resin-coated fiber roving onto a pipe wall is performed with a trowel or a roller assembly. In some embodiments, the method additionally includes curing or subjecting the spread or splayed fiber layer using heat treatment, light treatment (e.g., ultraviolet, infrared, etc.), electrical current treatment, air or other fluid treatment (e.g., ventilation) and/or the like. In other embodiments, the angle relative to the longitudinal axis at which the resin-coated fiber roving is positioned on the pipe wall is adjustable. In other arrangements, the second circumferential section at least partially overlaps the first circumferential section. In another embodiment, the second circumferential section generally abuts the first circumferential section. In some embodiments, the fiber roving comprises nylon, glass, graphite, polyaramid and/or other materials. In some embodiments, the resin comprises epoxy, polyurethane, acrylic, other polymeric materials and/or any other materials or substances. In some embodiments, the step of coating the raw fiber roving with resin comprises directing the raw fiber roving through a resin reservoir of a saturator. In alternative embodiments, the step of coating the raw fiber roving with resin comprises selectively spraying, dripping or otherwise applying resin onto the raw fiber roving. In some embodiments, the method further includes curing or post-application treatment using light treatment (e.g., ultraviolet, infrared, etc.), heat treatment, electrical current treatment, active or passive ventilation treatment (e.g., ambient, using a fan, blower or other fluid transfer device, etc.). In one embodiment, the step of further comprising curing is performed using a device or component coupled to the positioning assembly. In another embodiment, the concrete surface is part of a wall, beam, column, pipe and/or the like.

According to certain embodiments disclosed in the present application, a system for reinforcing an interior wall of a pipe includes a resin saturator configured to at least partially saturate a fiber bundle with an epoxy and a positioning assembly which includes one or more arms (e.g., shafts) and which is configured to receive a resin-saturated fiber bundle exiting the resin saturator. In some embodiments, the resin-saturated fiber bundle is configured to be selectively advanced through the positioning assembly and toward a distal end of the at least one arm. In one arrangement, the reinforcing system additionally includes a trowel located at the distal end of the arm. The trowel can be configured to splay the resin-saturated fiber bundle onto the pipe wall. In some configurations, the system comprises a controller for regulating the manner in which the resin-saturated fiber bundle is selectively advanced through the positioning assembly and to the trowel (e.g., whether bundle is advanced, the rate at which the bundle is advanced, etc.). In some arrangements, resin-saturated fiber bundle splayed by the trowel is configured to directly adhere to the pipe wall. In one embodiment, the positioning assembly includes a shaft that is configured to be grasped and manually manipulated by a user. In other embodiments, the positioning assembly is configured to selectively rotate about a longitudinal axis of the pipe to place resin-saturated fiber bundle along a circumference of the pipe wall.

According to some embodiments disclosed in the present application, a system for reinforcing an interior wall of a pipe, tunnel, chimney, other stack or other structure or item comprises a resin saturator configured to at least partially saturate or otherwise coat a carbon fiber bundle with an epoxy. The system further comprises a positioning assembly configured to receive a resin-saturated carbon fiber bundle exiting the resin saturator. In some arrangements, the positioning assembly includes one or more arms. In one embodiment, the resin-saturated carbon fiber bundle is configured to be selectively advanced through the positioning assembly and toward a distal end of the aim. The system further includes a trowel which is located at the distal end of the arm and which is generally configured to splay or otherwise spread the resin-saturated carbon fiber bundle onto the pipe wall. In some embodiments, the trowel is approximately 8 inches wide. In other embodiments, the width of the trowel is greater or less than 8 inches. In some arrangements, the trowel is removable from the positioning assembly for cleaning, repair, maintenance or replacement purposes. In certain arrangements, the system comprises a controller for regulating the manner in which the resin-saturated carbon fiber bundle is advanced through the positioning assembly and to the trowel. According to certain embodiments, the positioning assembly is configured to selectively rotate about a longitudinal axis of the pipe to place resin-saturated carbon fiber bundle along an entire circumference of the pipe wall. In some embodiments, resin-saturated carbon fiber bundle splayed by the trowel is configured to directly adhere to the pipe wall with or without the use of any tack coats or other layers.

In certain embodiments, the resin saturator is generally positioned between a spool of raw carbon fiber bundle and the positioning assembly, with the resin saturator comprising at least one roller assembly to help direct raw carbon fiber bundle from the spool through a resin reservoir. In other arrangements, the positioning assembly comprises at least one pinch roller assembly adapted to selectively advance the resin-saturated carbon fiber bundle toward the trowel. In other embodiments, the controller comprises a handheld device configured to be selectively operated by a user. Such a handheld device can be operatively connected to one or more other devices and/or components of the system using electrical (e.g., hardwired, wireless, etc.), mechanical, pneumatic and/or other types of connections, In another arrangement, the handheld device is configured to selectively operate at least one pinch roller assembly or other device adapted to advance the resin-saturated carbon fiber bundle to the distal end of the positioning assembly. In other embodiments, the positioning assembly comprises at least one joint that is configured to permit a user to modify an angle at which a resin-saturated carbon fiber bundle is placed on the pipe wall. In some arrangements, the controller is additionally configured to regulate the movement of the positioning assembly around the longitudinal axis of the pipe.

According to some arrangements, the positioning assembly is configured to be moved longitudinally within the pipe so as to provide resin-saturated carbon fiber bundles along a desired longitudinal section of the pipe wall. In some embodiments, the controller is additionally configured to control the longitudinal movement of the positioning assembly within the pipe. In one embodiment, the positioning assembly is secured to a support member having one or more legs configured to contact the pipe wall. In some embodiments, one leg of the support member contacts the pipe wall at a point generally diametrically opposite of the location that a second leg of the support member contacts the pipe wall. In certain arrangements, the support member is configured to be moved longitudinally within an interior of the pipe. In one embodiment, the support member comprises a movable (e.g., wheeled) tripod.

According to other embodiments, the carbon fiber bundle is provided on a spool. In some arrangements, the spool, the saturator, the positioning assembly and/or any other devices, components or equipment of the reinforcing system are located on a movable cart, said movable cart. In one embodiment, such a cart is configured to be moved (e.g., rolled, slid or otherwise translated along a longitudinal axis of the pipe) within an interior of the pipe. In some embodiments, the cart comprises a foot pedal, a lever and/or other controllers configured to selectively move the cart within the interior of the pipe. In other embodiments, the carbon fiber bundle comprises nylon, glass, graphite, polyaramid and/or any other polymeric material. In certain arrangements, the resin comprises epoxy, polyurethane, acrylic or another polymer with favorable cohesive strength characteristics.

According to certain embodiments, a method of reinforcing a pipe using carbon fiber reinforced polymer (CFRP) includes coating a raw carbon fiber roving with an epoxy, selectively directing the carbon fiber roving through a positioning assembly, splaying the carbon fiber roving that exits the positioning assembly onto a pipe wall, rotating the positioning assembly about an axis to place splayed carbon fiber roving along a first circumferential section of the pipe wall and moving the positioning assembly along a longitudinal axis of the pipe to selectively place splayed carbon fiber roving along a second circumferential section of the pipe wall.

In some arrangements, the method additionally includes providing a primer and/or any other coat or layer on the pipe wall prior to splaying carbon fiber roving thereto and/or at least one top coat over the splayed carbon fiber roving. In one embodiment, the step of selectively directing the carbon fiber roving through the positioning assembly comprises operating one or more pinch roller assemblies of the positioning assembly. In other embodiments, an angle relative to the longitudinal axis at which the carbon fiber roving is splayed is adjustable. In one embodiment, the second circumferential section at least partially overlaps the first circumferential section. In an alternative embodiment, the second circumferential section generally abuts the first circumferential section. According to certain embodiments, the carbon fiber roving comprises nylon, glass, graphite, polyaramid and/or other polymeric materials. In other arrangements, the resin comprises epoxy, polyurethane, acrylic and/or or another polymer with favorable cohesive strength characteristics. In some embodiments, the step of coating the raw carbon fiber roving with epoxy comprises directing the raw carbon fiber roving through a resin reservoir of a saturator. In other arrangements, the step of coating the raw carbon fiber roving with epoxy comprises spraying a resin onto raw carbon fiber roving.

### BRIEF DESCRIPTION OF THE DRAWINGS

These and other features, aspects and advantages of the present inventions are described with reference to drawings of certain preferred embodiments, which are intended to illustrate, but not to limit, the present inventions. The drawings include thirteen (13) figures. It is to be understood that the attached drawings are for the purpose of illustrating concepts of the present inventions and may not be to scale.

FIG. 1A illustrates a cross-sectional view of a reinforcing system being used to coat the interior wall of a pipe with fiber bundles or roving according to one embodiment;

FIG. 1B illustrates one embodiment of a bulk container having raw fiber bundles or roving;

FIG. 1C schematically illustrates a resin tank or other resin source configured to provide resin to a raw fiber bundle according to one embodiment;

FIG. 1D schematically illustrates one embodiment of a reinforcing system comprising a squeegee or other device or feature for removing at least some resin from a resin-saturated fiber bundle or roving;

FIG. 1E illustrates a squeegee or other device or feature for removing at least some resin from a resin-saturated fiber bundle or roving according to one embodiment;

FIG. 2A illustrates a detailed view of the distal end of the positioning assembly of the system of FIG. 1A;

FIG. 2B schematically illustrates a side view of one embodiment of a positioning assembly having two or more applicator assemblies or heads;

FIG. 2C schematically illustrates a side view of another embodiment of a positioning assembly having two or more applicator assemblies or heads;

FIG. 2D schematically illustrates a side view of yet another embodiment of a positioning assembly having a plurality of applicator assemblies or heads;

FIG. 3 illustrates a cross-sectional view of a reinforcing system being used to coat the interior wall of a pipe with fiber bundles or roving according to another embodiment;

FIG. 4 illustrates a cross-sectional view of a reinforcing system being used to coat the interior wall of a pipe with fiber bundles or roving according to yet another embodiment;

FIG. 5 illustrates a cross-sectional view of a reinforcing system being used to coat the interior wall of a pipe with fiber bundles or roving according to still another embodiment; and

FIG. 6 illustrates a cross-sectional view of a reinforcing system being used to coat a wall or other surface with fiber bundles or roving according to another embodiment.

### DETAILED DESCRIPTION OF THE PREFERRED EMBODIMENTS

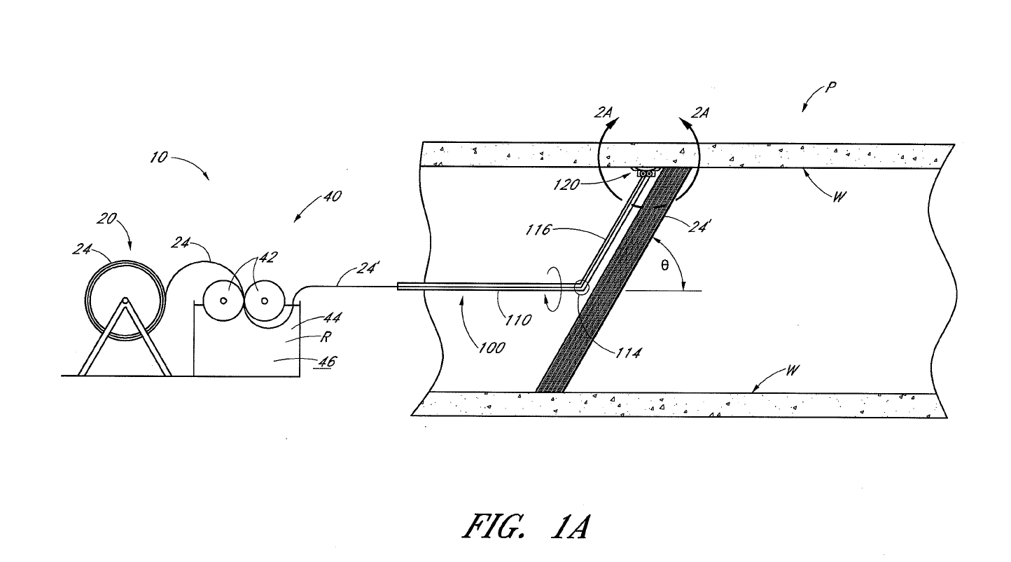

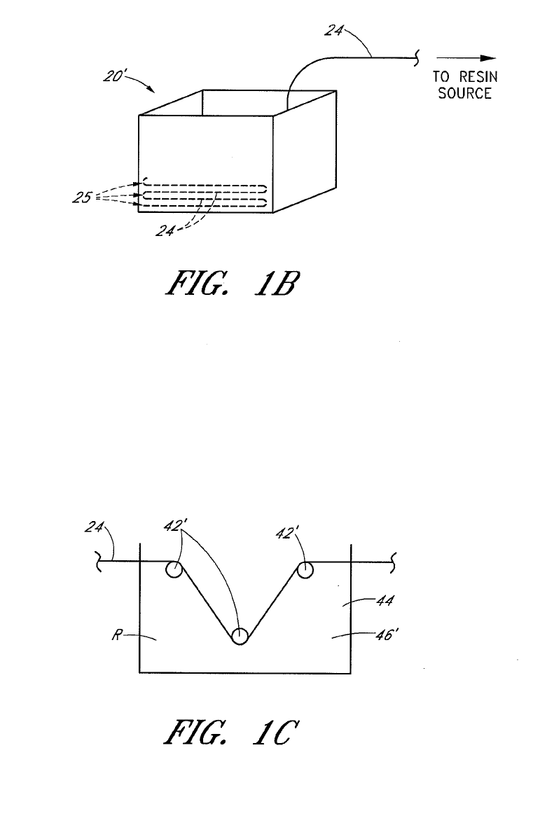

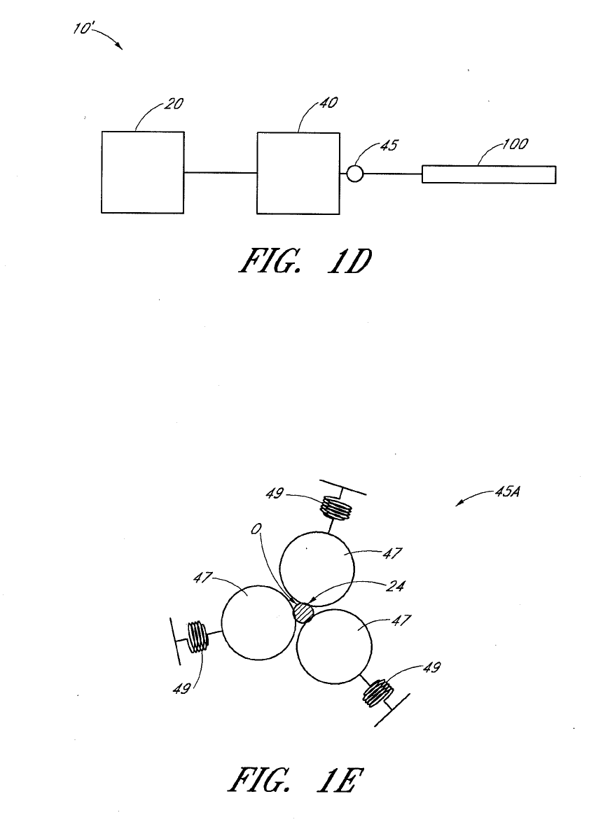

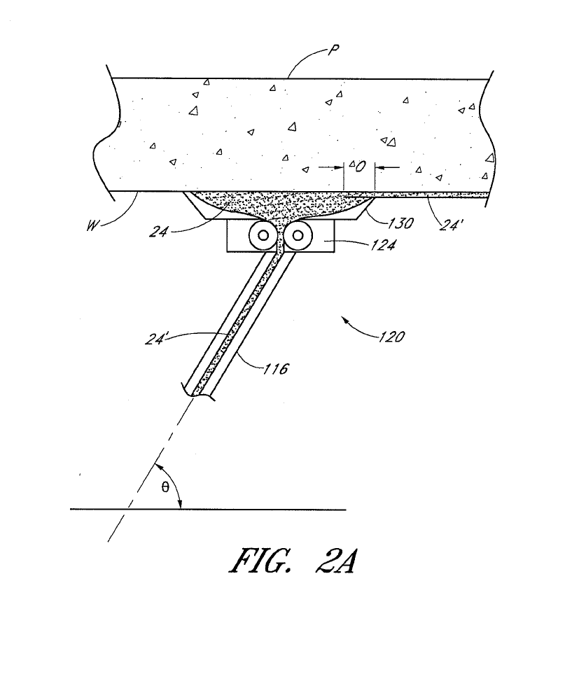

FIG. 1A illustrates one embodiment of a system 10 configured to reinforce an interior wall W of a pipe P. As discussed in greater detail herein, the system 10 can be adapted to provide one or more layers of fiber reinforced polymer, such as, for example, carbon fiber reinforced polymer (CFRP), to the pipe wall W. However, the devices, systems, methods and features disclosed herein, or equivalents thereof, can be modified so as to be used in the structural reinforcement of other below-ground and above-ground devices, structures or other items, such as, for example, tunnels, galleries, chimneys, smoke stacks, tanks, reservoirs, walls, other structures and/or the like.

As illustrated in FIG. 1A, according to some embodiments, raw carbon and/or other types of fiber can be provided on a spool 20 as roving or bundle 24. According to some embodiments, the carbon or other type of fiber roving or bundle 24 comprises loosely twisted filaments. For example, as illustrated in FIG. 1B, raw fiber bundle or roving 24 can be supplied in a box or other bulk container 20′. With continued reference to the embodiment that is schematically illustrated in FIG. 1B, the raw fiber bundle or roving 24 can be placed within the container 20′ using a layered or other back and forth orientation 25. In alternative embodiments, the bundle or roving 24 can include a spiral, spooled, and/or any other orientation within the box or other bulk container, as desired or required. Regardless of how the raw bundle or roving 24 is supplied, it can be configured to be easily routed to one or more downstream steps (e.g., delivered to and through a resin saturation system, a positioning assembly, a spreading member and/or the like. Like the spool (FIG. 1A), a box or other bulk container comprising raw bundle (e.g., resin-less fiber bundle), can advantageously provide a convenient, efficient and timely way of supplying fiber to a reinforcing system. In any of the embodiments disclosed herein, or equivalents thereof, a reinforcing system can include a spool, box or other container and/or any other device or component for supplying raw bundle or roving to the system.

According to some embodiments, the fiber used in such applications is supplied in its raw form. To further enhance their structural characteristics, these filaments can be generally continuous through an entire length of roving 24. Thus, in certain arrangements, the roving or bundle is not composed of short, fuzzy and discontinuous filaments that are held together by friction or some other method. The filaments of a roving or bundle 24 can comprise nylon, glass, graphite, polyaramid and/or any other type of material having the desired or required characteristics (e.g., tensile strength). However, in other embodiments, one or more non-carbon types of filaments (e.g., non-carbonaceous synthetics) are used, either in addition to or in lieu of carbon filaments. Thus, for any of the embodiments disclosed herein, any combination of carbon and/or non-carbon based fibers can be included in the roving or bundle that is splayed and placed on a pipe wall or other surface.

With continued reference to FIG. 1A, raw fiber bundle 24 can be directed from the spool 20, a bulk container or some other source to a saturator 40 or other container in order to provide a desired or required amount of resin R to the filaments of the roving 24. As discussed, the bundle 24 can include carbon and/or non-carbon filaments, as desired or required. In some embodiments, the bundle 24 can include one or more other materials to provide certain desired or required characteristics to the filaments and/or the actual reinforcing layer that will be applied to a pipe wall or other surface. In certain configurations, the resin R comprises epoxy, polyurethane, acrylic or any other binders or materials that have favorable cohesive strength. However, in any of the embodiments disclosed herein, the epoxy or other resin can be applied to raw carbon fiber using other devices or methods. For example, the resin can be sprayed, dripped and/or otherwise applied onto a roving or bundle as the carbon fiber bundle 24 is delivered from the spool 20, other container or other source. In alternative embodiments, fiber bundle or roving is passed through a resin tank or other container in order to saturate the bundle or roving with a desired quantity of resin. Additional information regarding the carbon fiber roving and resin is provided in U.S. patent application Ser. No. 10/205,294 filed on Jul. 24, 2002 and issued on Apr. 24, 2007 as U.S. Pat. No. 7,207,149, the entirety of which is hereby incorporated by reference herein.

The saturator or resin source 40 can include one or more roller assemblies 42 (e.g., pinch, press or pull rollers), other advancement valves or devices and/or other devices that are configured to push and/or pull the fiber roving or bundle 24 relative to the saturator's resin reservoir 44 (e.g., through an interior region 46 of the reservoir 44). An alternative embodiment of a roller 42′ or advancement configuration is illustrated in FIG. 1C. In other embodiments, the fiber bundle or roving is configured to be moved relative to a resin source (e.g., a resin tank, spray, other applicator, etc.) without the use of rollers or other advancement features located within or near a resin source. For example, in any of the embodiments of a reinforcing system described herein, or equivalents thereof, one or more rollers (e.g., push or pull) and/or other advancement features or devices can be located upstream and/or downstream of the resin source (e.g., a resin reservoir 44, 44′, spray, etc.).

In some embodiments, the rollers and/or other advancement devices included within a reinforcement system are configured to prevent or reduce the likelihood of the fiber bundle or roving from being twisted, stretched and/or otherwise moved as it is transferred from a raw fiber source (e.g., a spool, bulk container, etc.) to the applicator assembly or head of the positioning assembly. This can help avoid the application of undesirable forces and/or moments on the bundle or roving. In addition, this can help ensure that the resin-laden bundle or roving is adequately splayed or spread onto a pipe wall or other surface being reinforced.

In any of the arrangements described and illustrated herein, the saturator 40 can be selectively heated to maintain the resin R at a desired temperature. This can further enhance the ability of the resin to adequately saturate or otherwise coat the filaments of the roving 24 as the resins come into contact with the roving (e.g., as roving is passed through a resin tank or other container, as resin is sprayed, dripped or otherwise applied to roving, etc.). In some embodiments, the reinforcing system is configured so that the resin temperature is adjustable (e.g., automatically, partially-automatically, manually, etc.) so that the resin containing bundle comprises a desired temperature when it is applied to the pipe wall W. This can help ensure adequate adhesion of the CFRP to the pipe wall W. Thus, the need for additional coatings or layers and/or other post-application steps can be advantageously eliminated or reduced. The resin R can be conductively and/or convectively thermally-conditioned using one or more heating devices or methods (e.g., resistance heaters, heat exchange pipes, heat pumps, etc.). Relatedly, in some embodiments, the tank or other container in which the resin is housed includes (and/or is in thermal communication) with one or more sensors. For example, such sensors can include temperature sensors, viscosity sensors, density sensors and/or any other sensors that are configured to detect a physical, chemical or other property of the resin.

In certain embodiments, the resin R is maintained at a desired or required level within the saturator 40. The saturator's reservoir 44 can be in fluid communication with a separate resin container (not shown), such as, for example, a 55-gallon drum or other source container. Thus, as resin R is transferred from the saturator 40 to the roving 24, additional resin R can be automatically or manually directed into the saturator 40. For example, the saturator's reservoir 44 can include a level sensor or other device configured to automatically detect the top level of the resin R stored therein. In such an embodiment, data and other information obtained by the level sensor can be used to open a valve, operate a pump or otherwise direct additional resin R to the saturator 40. Alternatively, a user can manually direct additional resin R into the saturator's reservoir 44 to maintain a desired level. For example, the user can manually open a valve or operate a pumping device to fill the reservoir 44. In another configuration, a user can manually transfer resin R into the reservoir 44 (e.g., using a bucket or other container).

In other embodiments, the resin R contained within the saturator reservoir 44 is maintained at a constant or substantially constant level using one or more other devices or methods. For instance, the reservoir 44 can be positioned on springs or other resilient members that are configured to automatically or manually lift and/or lower the bottom level of the reservoir to maintain a desired resin level therein. In some embodiments, level sensing within a resin reservoir or other container is accomplished by measuring a weight of the reservoir or container, such as by using a load cell, balance, or other weight measurement device. In further embodiments, float systems are adapted for use in determining a level of resin within the reservoir. In some instances, it may also be desirable to perform such fill level measurements without the sensor physically contacting the reservoir (or other container) or the contents within the reservoir. A reinforcing system can include any other type of sensor to help measure the level of resin within a reservoir, such as, for example, floats, sight glasses, ultrasonic, infrared, laser or similar systems, other light-based sensors and/or the like.

In alternative embodiments, the level of the resin within the reservoir 44 is configured to change (e.g., lower) over time. In such arrangements, the roller assemblies 42 and/or other devices or systems that help direct the roving within or through the reservoir 44 can be configured to change elevation in response to a changing resin level within the reservoir 44.

As illustrated in FIG. 1A, raw carbon bundle 24 can be directed through an interior portion 46 of the saturator reservoir 44. The thickness and density of the bundle 24, the materials used to manufacture the bundle 24, the path and velocity of the bundle 24 through the resin R, the contact time between the bundle 24 and the resin R, the temperature of the resin R and/or other factors can be varied to achieve a desired CFRP bundle 24′ exiting the saturator 40. As discussed in greater detail herein, once it exits the saturator 40, the resin-saturated or resin-laden bundle 24′ can be directed to a positioning assembly 100 configured to selectively apply the CFRP along the inner wall W of the pipe P, in accordance with particular preferences and design criteria.

In any of the embodiments disclosed herein, the reinforcing system can comprise one or more resin eliminating devices to help remove excess resin from the bundle or roving as the bundle or roving is moved toward the positioning assembly. FIG. 1D schematically illustrates one embodiment of a reinforcing system 10′ that includes one or more resin removal devices 45 configured to remove excess resin after resin has been applied to raw roving or bundle. In the depicted arrangement, the resin removal device 45 is located immediately downstream of a resin reservoir or other resin source 40 (e.g. spray or dip applicator, etc.). In alternative embodiments, one or more resin removal devices 45 can be located within a resin reservoir or other resin source, either in lieu of or in addition to being at a downstream and separate location from the reservoir or source.

The resin removal device 45 can comprise one or more squeegees, wipers or wiper systems, rollers, other mechanical members or devices, and/or any other stationary or movable devices or members. For example, FIG. 1E illustrates one embodiment of a resin removal device 45A comprising three rollers 47 or similar devices that are configured to provide a space or other opening O through which resin-laden bundle or roving 24 may be passed. In one arrangement, the opening O is sized and shaped to squeeze a certain amount of resin from the bundle 24.

With continued reference to the resin removal device 45 of FIG. 1E, the rollers can be resiliently biased toward each other using a spring or other biasing member 49. Thus, the squeezing pressure applied to the bundle 24 can be adjustable in that the rollers can be adapted to move away from each other in order to increase the size of the opening O through which the bundle 24 is passed. In some embodiments, the rollers 47 are configured to rotate, at least partially, as the bundle 24 is moved through the opening of the resin removal device 45. In other embodiments, however, the rollers 47 are stationary. In one arrangement, the rollers 47 are configured to both remove excess resin from roving and to help advance the roving through the reinforcing system. The reinforcing system can include one or more sensors that are configured to determine the level of resin saturation of fiber bundle or roving as it is being directed toward a positioning assembly. For example, such sensors can include a liquid content sensor, a viscosity or density sensor and/or the like. Thus, the system can use feedback provided by such sensors to automatically or manually adjust the amount of resin that is removed from resin-laden bundle or roving. As noted above, one or more resin removal devices can be incorporated into any of the reinforcing system disclosed herein.

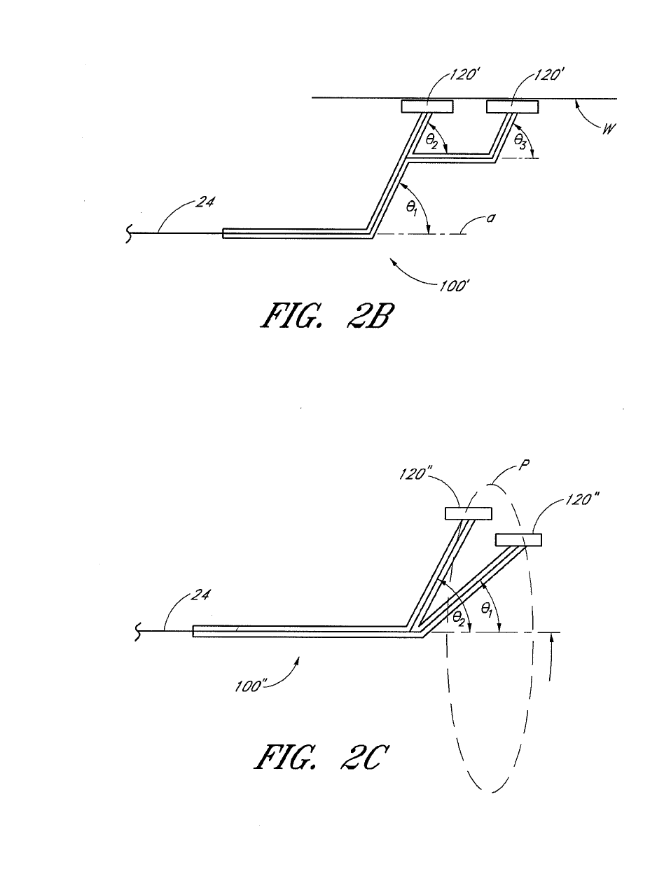

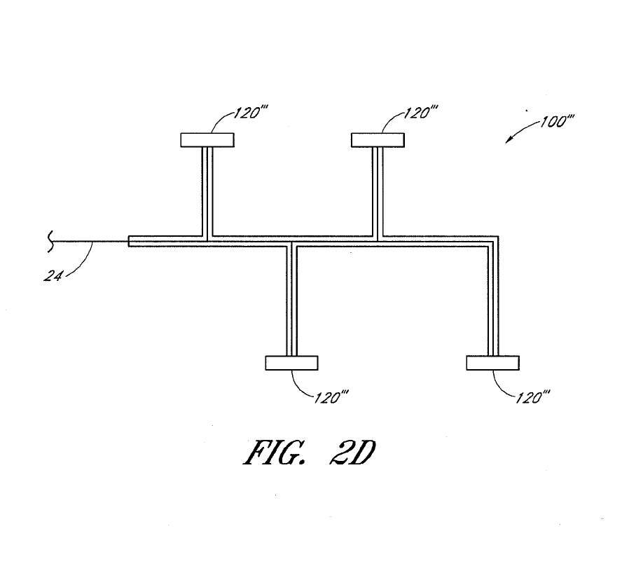

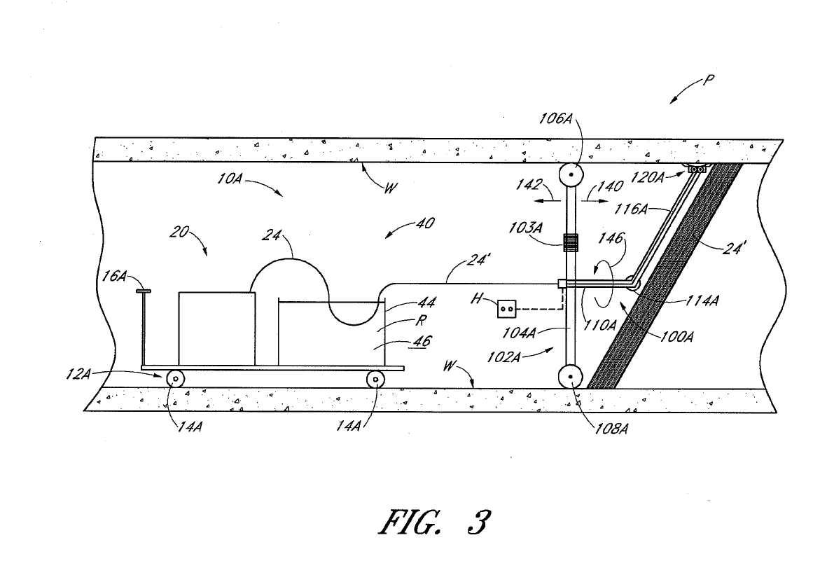

With continued reference to FIG. 1A, the positioning assembly 100 can include a tube, pipe, other conduit and/or other hollow channel through which the CFRP bundle or roving 24′ can be routed. As shown in FIG. 1A, in some embodiments, the positioning assembly 100 comprises a distal arm 116 that is attached to a proximal arm 110 at a joint 114 or other connection point. Alternatively, the proximal and distal arms 110, 116 can include a unitary structure. In other configurations, the positioning assembly 100 includes more or fewer arms, joints and/or other components, as desired or required. In the depicted embodiment, the proximal arm 110 is substantially horizontal relative to the longitudinal axis of the pipe P. Further, the proximal arm 110 can be generally aligned with the vertical center or centerline of the pipe (e.g., half-way between the upper and lower inner walls W). As shown, the distal arm 116 can be angled relative to the proximal arm 110 along the joint 114 or other bending point. Thus, a resin-saturated CFRP bundle 24′ can be transported through the proximal and distal arms 110, 116 of the positioning assembly 100 and toward the applicator assembly 120 or head. However, as discussed in greater detail herein, the position, orientation and other details about the positioning assembly 100, including the location of its components relative each other, the pipe wall and/or the like can vary, as desired or required. Further, according to some embodiments, as discussed herein for example with reference to FIGS. 2B-2D, a positioning assembly can include two or more applicator assemblies or heads.

FIG. 2A illustrates one embodiment of an applicator assembly 120 or head positioned at or near an end of the distal arm 116. In the depicted arrangement, the applicator assembly 120 comprises a pinch or press roller 124, other roller assembly and/or other advancing device configured to selectively pull (and/or push) the resin-laden bundle or roving 24′ through the positioning assembly 100. A positioning assembly 100 can include additional rollers 124 and/or other devices or features to help deliver the bundle 24′ to the applicator assembly 120 or head, as desired or required. For example, the positioning assembly 100 can comprise rollers 124 or other devices in each arm 110, 116, at or near the joint 114 between the arms and/or at any other location, either in lieu of or in addition to the roller 124 illustrated in FIGS. 1A and 2A. In other embodiments, one or more pneumatic and/or mechanical devices are used to help advance the CFRP from the saturator to the applicator assembly 120 or head. The use of one or more rollers or similar devices can help to adequately spread, squeeze or otherwise shape the roving or bundle into a flatter orientation prior to contacting a pipe wall or other surface that is being reinforced. Further, the use of such rollers can help ensure that the fibers of the bundle are not twisted, stretched and/or otherwise moved during the application process in a manner that would negatively affect the strength, flexibility, other structural characteristics, attachment or bonding characteristics and/or other properties of the resulting splayed layer. The rollers used in the reinforcing system can selectively moved using one or more mechanically and/or pneumatically-operated motors, such as, for example, AC motors, DC motors, servo motors, synchronous electric motors, induction motors, electrostatic motors, other types of motors, combinations thereof and/or the like.

The pinch or press rollers 124 and/or any other device used to selectively deliver the CFRP roving 24′ to the pipe wall W can be regulated using a controller. For example, one or more pneumatic, mechanical and/or electrical connectors can be used to operatively connect a controller to the pinch or press roller 124 and/or any other portion of the positioning assembly 100. In certain embodiments, the controller comprises a handheld wand or other device (not shown) that a user can easily handle and manipulate during the execution of a pipe reinforcing procedure. In other arrangements, as discussed in greater detail herein, a controller can be incorporated into an automatic or semi-automatic system, such as, for example, a robot or robotic assembly, that is adapted to make the necessary operational adjustments with limited or no user supervision.

With continued reference to FIG. 2A, once the CFRP roving 24′ is pulled through the rollers 124 or another component or device, it can be directed to a spreading member 130. As shown, the spreading member 130 can be adapted to splay or otherwise spread the resin-impregnated roving 24′ in a desired manner. According to several embodiments, the spreading member 130 comprises a trowel, a press roller and/or the like. In some embodiments, the spreading member 130 forces the splayed CFRP roving 24′ against a portion of the pipe's inner wall W or other surface in need of reinforcement. Accordingly, if the resin comprises the desired or required cohesive characteristics, the splayed CFRP roving 24′ will remain on the pipe wall W. For example, the splayed CFRP roving 24′ can be adapted to remain on the pipe wall W without the need for additional coating procedures or other treatment steps. In addition, the spreading member 130 (e.g., trowel, roller or roller system, etc.) can be shaped, sized and otherwise configured to enhance the placement of the CFRP roving 24′ onto the pipe wall W by imparting an urging force against the roving 24′. In some embodiments, the spreading member 130 comprises one or more rigid, semi-rigid and/or flexible materials, such as, for example, plastic or other polymeric materials, rubber or other elastomeric materials, metal, wood, another synthetic or natural material and/or the like. In one embodiment, the spreading member 130 comprises a trowel that is approximately 8 inches wide. In other embodiments, the approximate width of the trowel 130 is greater or less than 8 inches (e.g., less than 2 inches, 2 inches, 3 inches, 4 inches, 5 inches, 6 inches, 7 inches, 9 inches, 10 inches, 12 inches, 24 inches, less than 1 inch, greater than 24 inches, widths between these values, etc.). However, the size, shape and/or other characteristics of the trowel, roller system or other spreading member 130 can vary. Further, the spreading member 130 can be configured to be removed from the positioning assembly 100 for cleaning, maintenance, inspection, repair, replacement or any other purpose.

According to some arrangements, as illustrated in FIGS. 1A and 2A, the positioning assembly 100 is configured to circumferentially rotate within the pipe interior (e.g., about and/or along a longitudinal axis of the pipe) so that the one or more applicator assemblies 120 or heads can be selectively moved around the pipe's inner diameter. For example, the distal arm 116 of the positioning assembly 100 can be selectively rotated around one or more joints 114 or other revolving members. Alternatively, the proximal arm 110, the joint 114 and the distal arm 116 can be configured to rotate within the pipe interior as a unitary structure. In other embodiments, the entire positioning assembly 100 can be configured to rotate about a longitudinal axis of a pipe, either alone or in conjunction with one or more other portions of the reinforcing system 10. Regardless of the exact manner in which the application assembly and/or one or more other components of the system are configured to move, the applicator assembly 120 or head can travel around an entire circumferential region of the pipe interior to selectively place one or more layers of splayed CFRP roving 24′ against the pipe wall W. Accordingly, as the positioning assembly 100 rotates, it can be translated along the longitudinal axis of the pipe P to position one or more coats or layers of a desired length of pipe with CFRP roving 24′.

In some embodiments, the angle θ (FIGS. 1A and 2A) formed between the distal arm 116 and the proximal arm 110 (and thus, the surface of the pipe's inner wall W) can be fixed or adjustable. As a result, in such an embodiment, the filaments in the CFRP roving 24′ can also be orientated at or near an angle θ relative to pipe wall W. The angle θ can be advantageously selected to satisfy certain design criteria and/or to achieve certain desired structural characteristics. For example, in some embodiments, the angle θ is about 54.7° or approximately 54.7°. However, the angle θ can be less than or greater than 54.7°, as desired or required for a particular project or design. For example, in some embodiments, the angle θ is between about 0° and 10°, about 10° and 20°, about 20° and 30°, about 30° and 40°, about 40° and 50°, about 50° and 60°, about 60° and 70°, about 70° and 80°, about 80° and 90°, about 90° and 100°, about 100° and 110°, about 110° and 120°, about 120° and 130°, about 130° and 140°, about 140° and 150°, about 150° and 160°, about 160° and 170°, about 170° and 180°, values between such ranges and/or the like. In other embodiments, however, the positioning assembly of the system includes only a single arm or member.

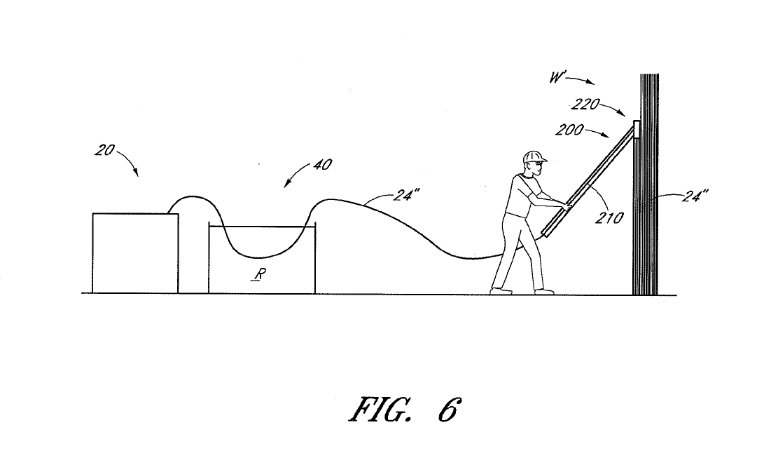

According to some embodiments, as discussed in greater detail herein with reference to FIG. 5, the spread or splayed layers of CFRP roving 24′ can be applied to a pipe wall W or other surface using a simpler positioning assembly 100C. As illustrated in FIG. 5, the positioning assembly 100C can comprise a handheld arm, pole or other rod that a user selectively moves over a desired surface of a pipe wall W to place CFRP thereon. Additional details regarding such arrangements are provided below.

In yet other embodiments, a positioning assembly, a resin reservoir or applicator, a bundle or roving holder and/or other components of a system are included within a single robotic assembly. Such a robotic assembly can be configured to advantageously move along a longitudinal axis of a pipe or relative to a wall or other structural member in order to apply one or more layers of splayed and resin-impregnated CFRP thereon.

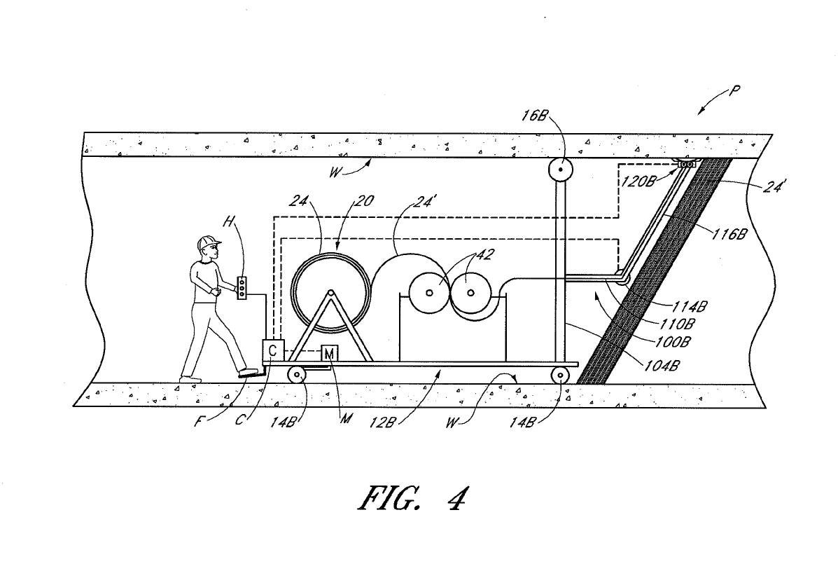

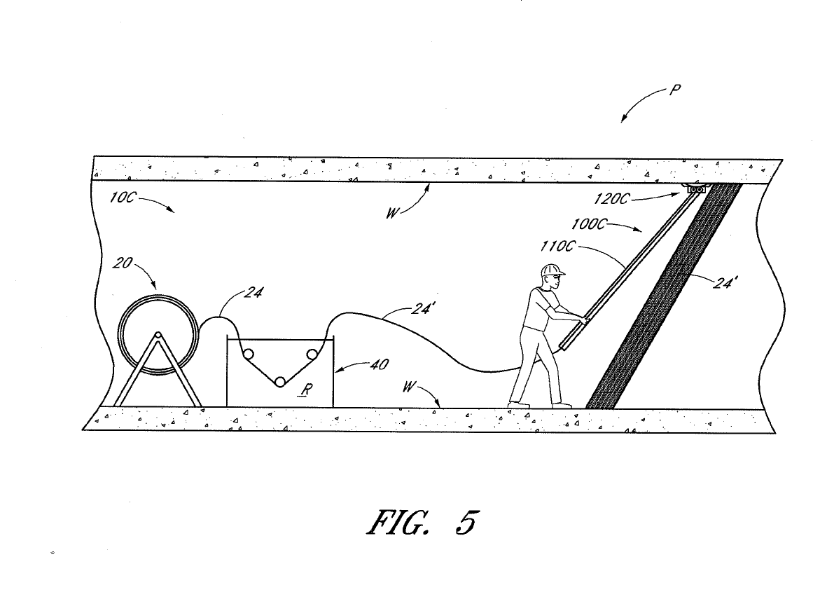

Depending on the target design parameters, the one or more applicator assemblies 120 or heads of the positioning assembly can be configured to deposit one, two or more layers of splayed or spread CFRP roving 24′ over a particular section of the pipe wall W and/or any other portion of a structure (e.g., wall, column, beam, slab, etc.). In some embodiments, adjacent layers of splayed CFRP roving 24′ are configured to at least partially overlap so that a section of the pipe's inner wall W is continuously covered by CFRP. For example, adjacent splayed layer of CFRP can be configured to overlap by less than ½ inch, ½ inch, 1 inch, 2 inches, 3 inches, 4 inches, less than ½ inch, more than 4 inches, ranges between such values and/or any other length. As discussed, the positioning assembly 100 can be configured to be moved (e.g., either automatically or manually) within the pipe in order to provide successive layers of splayed CFRP roving 24′ along a targeted section of the pipe wall W. For example, as illustrated in FIGS. 3 and 4, a positioning assembly can be situated on a rollable cart, tripod and/or other movable device. In other embodiments, as discussed in greater detail herein, a positioning assembly can be incorporated into a robotic member or other automatically movable device.

In any embodiments disclosed herein, a reinforcing system, regardless of whether it is manual or partially or fully automated (e.g., robotic), can comprise two or more applicator assemblies or heads extending from a positioning assembly. As discussed in greater detail herein, such applicator assemblies can permit a system to simultaneously apply two or more layers of resin-impregnated, splayed fiber bundle (e.g., CFRP) on a pipe wall or other surface. Such layers can be adjacent to each other with little or no overlap. In alternative arrangements, the applicator assemblies are generally within the same radial plane so that the layers splayed or otherwise deposited onto a wall or other surface overlap or substantially overlap.

For example, with reference to the embodiment schematically illustrated in FIG. 2B, a reinforcing system can comprise a positioning assembly 100′ comprising two or more applicator assemblies 120′ or heads. In the depicted arrangement, the heads 120′ are offset from each other such that when positioning assembly 100′ is rotated about a longitudinal axis (a) the heads 120′ will apply a layer of splayed fiber bundle or roving to different longitudinal portions of the pipe's interior wall W. Thus, as the positioning assembly 100′ is moved within a pipe, the more distal of the applicator assemblies 120′ will provide a second layer of splayed fiber bundle over the first layer applied by the proximal applicator assembly 120′. In other arrangements, a positioning assembly can include more (e.g., three, four, five, more than five, etc.) or fewer (e.g., one) applicator assemblies 120′, as desired or required for a particular application or use.

With continued reference to FIG. 2B, the positioning assembly 100′ can be configured to permit a user to adjust the angle at which the various layers of splayed or spread fiber roving or bundle are placed on a wall W. For example, in the depicted embodiment, the various arms, segments or other components of the positioning assembly 100′ can be configured to be moved so as to selectively adjust the various relative angles θ₁, θ₂, θ₃ formed between them.

FIG. 2C illustrates one embodiment of a positioning assembly 100″ having two applicator assemblies 120″ or heads within the same or substantially the same radial plane P. Thus, as the positioning assembly 100″ rotates about its longitudinal axis during use, the heads 120″ are configured to sequentially apply overlapping or substantially overlapping layers of splayed fiber bundle onto a wall or other surface. In some embodiments, the reinforcing system is configured so that the radial position, the application angle θ₁, θ₂ and/or one or more characteristics associated with each applicator assembly 120″ or head can be adjusted (e.g., either independently or simultaneously of each other), as desired or required for a particular application or use.

Another embodiment of a positioning assembly 100′″ having two or more applicator assemblies 120′″ or heads is schematically illustrated in FIG. 2D. In the depicted arrangement, the positioning assembly 100′″ comprises a total of four heads 120′″. However, in alternative embodiments, a positioning assembly includes more or fewer heads 120′″. As shown, the heads or applicator assemblies 120′″ can be offset from each other. Thus, in such an embodiment, the reinforcing system can simultaneously apply splayed layers of resin-impregnated fiber bundle or roving along different longitudinal portions of an interior pipe wall or other surface being retrofitted. In other configurations, two or more of the applicator assemblies or heads 120′″ are within the same plane or substantially within the same plane.

Another embodiment of a reinforcing system 10A utilizing CFRP roving or bundle 24′ is illustrated in FIG. 3. As shown, the positioning assembly 100A can be mounted on a tripod 102A, robotic member or other movable structure. The tripod 102A can include upper wheels 106A configured to contact an upper portion of the pipe inner wall W and lower wheels 108A configured to contact a lower portion of the pipe inner wall W. According to some arrangements, a structure 104A (e.g., one or more struts, columns and/or other members) can generally extend between the upper and lower wheels 106A, 108A of the tripod 102A. The height of the tripod 102A can be selectively adjusted to permit the tripod 102A to be used in variety of different pipes P and/or other structures that require structural reinforcement (e.g., tunnels, stacks, etc.). In one embodiment, the tripod 102A includes a spring 103A, other resilient member and/or any other device that is generally configured to permit the structure 103A to be compressed (e.g., so as to decrease the effective height of the tripod 102A). Further, such a spring 103A can help urge the upper and lower wheels 106A, 108A (or other contact members) against diametrically opposed portions of the pipe's inner wall W. Thus, the tripod 102A can be securely maintained in a desired orientation (e.g., perpendicular to the longitudinal axis of the pipe P) during use. One or more other methods or devices for positioning and stabilizing the tripod 102A or other support member within a pipe P can also be used, either in lieu of or in addition to the vertical adjustment feature or the spring 103A disclosed herein.

Moreover, in any of the embodiments disclosed herein or variations thereof, the length of the proximal and distal arms of the positioning assembly can be adjustable. This can advantageously permit the positioning assembly to be selectively sized according to the pipe P or other structure into which it will be inserted and used. Further, in some embodiments, the joint or other bending member located between adjacent arms and/or other portions of a positioning assembly is configured so that the angle θ (e.g., the relative angle between the distal arm of the positioning assembly and the longitudinal axis of the pipe P) at which the fibers within the CFRP will be placed relative to the pipe wall W can be selectively adjusted. As noted herein, in some embodiments, the reinforcing system includes a positioning assembly that does not comprise multiple arms or members, and thus, does not require a joint or other bending member.

According to some arrangements, as illustrated in FIG. 3, the positioning assembly 100A is advantageously secured to the tripod 102A or other support structure. This can facilitate movement of the positioning assembly 100A within the interior of the pipe (e.g., longitudinally within the pipe, in directions generally represented by arrows 140 and 142). Thus, as shown in FIG. 3 and discussed in greater detail herein, a plurality of successive layers of resin-impregnated and splayed or spread CFRP roving 24′ can be easily and accurately placed along a targeted section of the pipe wall W. As discussed herein, such layers of splayed roving 24′ can be configured so that they generally butt up against each other. In other embodiments, successive layers of resin-impregnated roving or bundles do not butt against each other (e.g., a gap exists between adjacent layers), partially or completely overlap with each other and/or have any other relative orientation, as desired or required.

In some embodiments, as illustrated in FIG. 3, the system 10A can include a manual or automatic controller H (e.g., handheld device, a control module, etc.) configured to operate one or more devices or aspects of the system. In certain arrangements, the controller H is operatively connected to one or more components of the positioning assembly 100A. For example, the controller H can be adapted to operate one or more rollers (e.g., or other devices that help advance CFRP roving 24′ through the positioning assembly 100A (e.g., the arms 110A, 116A of the assembly) and/or to adjust the horizontal position of the tripod 102A to which the positioning assembly 100A is attached. Further, such a controller H can help control the rotation of the distal arm 116A and/or other portions of the positioning assembly (e.g., around a longitudinal axis of the proximal arm 110A) while the CFRP roving 24′ is being placed along the interior wall W of the pipe. One or more other devices or aspects of the system 10A can also be regulated using a controller, either in addition to or in lieu of those explicitly disclosed herein.

In some arrangements, the manual or automatic controller H (e.g., a handheld device) is operatively connected to one or more of the devices, components or sub-systems of the reinforcing system using electrical (e.g., hardwired, wireless, etc.), pneumatic (e.g., compressed air or other fluids), mechanical and/or other types of connections. According to certain configurations, the handheld device or other controller H is operatively connected to one or more other processors, control units, other controllers, mechanical or pneumatic devices and/or the like, as desired or required for the proper operation of a system 10A. Accordingly, the movements and other features of the various components of a system 10A can be conveniently and accurate regulated using one or more controllers (e.g., handheld device H). In other embodiments, as discussed herein with reference to FIG. 4, a system is partially or fully automated so that one or more operations and/or functions of the system can be executed without direction from a user. In such arrangements, the reinforcing system includes a robotic assembly that is configured to automatically position one or more layers of resin-impregnated and splayed fiber roving or bundle along a target surface (e.g., the interior wall of a pipe, the exterior wall of a pipe, a structural wall, a beam, a column and/or the like).

In FIG. 3, the spool 20, bulk container or other source of raw roving or bundle 24 and the saturator 40 are generally positioned on a movable cart 12A. As shown, the cart 12A can include a plurality of wheels 14A so that it can be conveniently moved within an interior of a pipe P. For example, in one embodiment, the cart 12A is moved during a coating procedure to maintain a desired separation distance with the positioning assembly 100A and the tripod 102A. The cart 12A can be moved manually or automatically (e.g., robotically). Further, the cart 12A can be moved with or without the assistance of an external source. For example, the cart can be configured to be moved using a handle 16A or other manual actuator. In alternative embodiments, the cart is adapted to be moved with the assistance one a motor and/or some propelling device (e.g., mechanical, pneumatic, electric, etc.), as desired or required.

In other embodiments, the cart 12A can include wheel assemblies that engage different portions of the pipe's interior wall (e.g., upper, lower, side portions, etc.). For example, in one arrangement, the cart includes wheels that project outwardly toward the inner pipe wall at various directions.

According to several configurations, the entire or substantially the entire reinforcing system is incorporated into a robotic device. For example, the tripod or other support structure for the positioning assembly can be provided on the cart 12A. Thus, the system can be configured to travel along a pipe interior (or other region that requires reinforcement) with all or substantially all of the fiber reinforcing components included within a unitary movable member.

Another embodiment of a pipe reinforcing system 10B is illustrated in FIG. 4. As shown, all, substantially all or most of the devices and other equipment required to place splayed or spread CFRP roving 24′ onto a pipe wall W or other member can be included on a single cart 12B. For example, the cart 12B can be configured to support the spool 20, bulk container or other source of raw carbon roving or bundle 24, the saturator 40, the positioning assembly 100B and/or the like. According to certain embodiments, the cart 12B and the various devices and other items positioned thereon are adapted to function in accordance with a desired protocol or set of instructions. Thus, the process by which the inner wall W of the pipe is reinforced with CFRP roving 24′ can be fully automated or at least partially automated. For example, as shown, the system 10B can include a main controller C or processor that is operatively connected to some or all of the devices and/or components of the system 10B (e.g., the pinch or press rollers of the applicator assembly 120B, the rotational mechanism of the positioning assembly 100B, the rollers 42 of the saturator, etc.). Further, the system can include one or more position sensors, temperature or humidity sensors, pressure sensors, other detection devices and/or any other components that are also configured to be in data communication with the controller C or other processor. Thus, to assist in accurately executing a particular CFRP coating procedure, the system 10B can be operated with one or more feedback loops. Such a controller C can be positioned on the cart 12B or at any other location within or remote to the pipe P being retrofitted or repaired.

With continued reference to FIG. 4, the cart 12B can include a motor M or other device that is configured to selectively propel the cart 12B in a desired manner (e.g., rotate the wheels 14B). As with other devices and components of the system 10B, the motor M can be operatively connected to a controller C or other processor. In the illustrated embodiment, a user can adjust the position of the cart 12B using a foot pedal F. However, any other type of controller (e.g., lever, handle, knob, switch, button, etc.) can be used either in lieu of or in addition to a foot pedal. Further, in robotic or other fully automated embodiments, the reinforcement system is configured to be operated without an operator or other user being in the vicinity of the system. In such arrangements, the controller of the system can be in data communication with a remote controller (e.g., handheld device) that permits a user to operate the system from a distance (e.g., while outside a pipe interior, generally away from a location of the wall, beam and/or other structure that is being reinforced using resin-impregnated fiber bundles or roving. In still other embodiments, the reinforcement system comprises one or more cameras or other devices that advantageously provide visual feedback to an operator who is located at a remote location. This can further facilitate the operator's ability to accurately control the system.

According to other embodiments, the system 10B includes a handheld device H that is configured to be operatively connected, either directly or indirectly (e.g., through a controller C or main processor), to other devices or components of the system 10B. As shown, a user can conveniently handle and manipulate such a handheld device H during the execution of a reinforcing procedure.

With continued reference to FIG. 5, a reinforcing system 10C can be simplified so that a positioning assembly 100C is configured to be handled and selectively moved directly by a user. As shown, the positioning assembly 100C can include a shaft 110C or other handle portion having an application assembly 120C at its distal end. The shaft 110C can be adapted to be grasped and manipulated by a user to place CFRP roving 24′ being directed therethrough onto the pipe wall W. Thus, with such an arrangement, the user may be required to manually rotate and/or otherwise move the shaft 110C of the positioning assembly 100C along a portion of the pipe wall W. For example, the user can rotate the shaft 110C along an interior circumference and/or longitudinally move the shaft 110C along a desired portion of the pipe wall W. Accordingly, in such embodiments, the need for a more intricate positioning assembly, a tripod or other device to support the positioning assembly and/or other components of the system 10C can be simplified or eliminated. These simplified arrangements can be particularly useful when access to the interior of a pipe or access to another structure or item in need of reinforcement is difficult (e.g., smaller pipes, confined areas, etc.).

As discussed with reference to other embodiments herein, the depicted system 10C can include one or more controllers (not shown) on or near the shaft 110C or operatively connected to the positioning assembly 100C. Such a controller can allow a user to easily and conveniently advance resin-coated CFRP through the positioning assembly 100C, the trowel and other portions of the applicator assembly 120C in order to selectively place splayed CFRP onto the a desired portion of the pipe wall W or other surface. For example, the controller can include a lever, switch, knob or other device configured to operate a pinch roller located at or near the applicator assembly 120C.

As noted above, the various embodiments of the reinforcement systems disclosed herein can be used to strengthen or otherwise retrofit any structural or non-structural member, such as, for example, a shear wall, a load-bearing wall, another type of wall, beam, column and/or the like.

FIG. 6 illustrates one embodiment of a reinforcing system being applied to one or more surfaces of a wall W′. In the depicted arrangement, an operator is using a simplified reinforcing system to apply one or more layers 24″ of resin-coated CFRP to the wall W′. As shown, the system includes a positioning assembly 200 that is configured to be handled and selectively moved directly by a user. As shown, the positioning assembly 200 can include a main shaft 210 or other handle portion comprising an application assembly 220 at its distal end. As discussed with reference to other embodiments herein, the CFRP layers 24″ can be oriented in any orientation to provide a desired or required design. For example, as illustrated in FIG. 6, the layers 24″ can be oriented in a generally vertical direction. However, in alternative embodiments, the orientation of the CFRP layers 24″ can be generally horizontal and/or diagonal, either in addition to or in lieu of vertical. Further, the various layers 24″ positioned on a wall, location or structure can be generally parallel or non-parallel (e.g., perpendicular, diagonal, etc.) to each other. Thus, in some embodiments, CFRP layers 24″ can be applied to a surface so that they completely or partially overlap, regardless of their relative orientation to each other.

According to some embodiments, a wall (e.g., interior pipe wall, exterior wall, etc.), structural component (e.g., beam, column, slab, wall, etc.) or surface that is to be reinforced can undergo one or more preparatory steps, either in advance of, during or after the delivery of resin-impregnated, splayed fiber bundle thereon. For example, such prepping can include scouring or blasting the wall or surface to be treated with high-pressure water (or other liquids, gases or fluids), sand, other particulates or solids and/or any other materials. Such scouring can help clean the wall or other surface and/or at least partially remove one or more films, layers or portions of such wall or surface in preparation for the subsequent application of CFRP or other fiber-reinforced resin layers. For example, the exposed surface of a concrete surface can be at least partially scoured and/or removed to expose underlying portions of concrete. This can help provide a better surface on which to apply one or more layers of resin-laden splayed (or otherwise spread) fiber bundle or roving. For example, such layers of splayed bundle can be directly applied to a wall, without the use of any other coats or layers (e.g., tack coats, binders, primers, grout, adhesives, etc.). In other embodiments, one or more intermediate layers or coatings are provided between a wall and the splayed fiber bundle.

In some embodiments, any of the reinforcing systems or methods disclosed herein can be used without pre-application or post-application coatings and/or other treatment steps. For example, in some arrangements, CFRP or other resin-impregnated fiber bundle or roving can be splayed and attached to a wall or other surface without the use of tack coats, primers, heat treatment, light treatment, other curing steps, additional top layers of paint or top coats and/or the like. In some embodiments, the fiber bundle is delivered to a wall or other surface with a proper amount of epoxy (e.g., within a desired or required range) and/or other resin so that it effectively directly adheres to such a wall or other surface. This can offer certain advantages over traditional fiber reinforcing methods. For example, using resin-impregnated fiber bundle provides a lighter alternative to fiber fabrics, liners, sheets, panels or other pre-formed materials that are coated with resin and applied to a wall or other surface. Accordingly, the need for curing and/or other post-application procedure is either reduced or eliminated. In addition, as discussed in greater detail herein, it is generally easier, faster, cheaper and more convenient to transport and apply the materials required in the present reinforcing methods.

In any of the embodiments disclosed herein, or equivalents thereof, a reinforcing system can include one or more devices that provide the desired curing or post-application treatment, as discussed above. For example, in some embodiments, a positioning member includes one or more heads (e.g., similar to one or more of the heads or applicator assemblies illustrated in FIGS. 2B-2D) that are configured to advantageously provide heat treatment, light treatment, ventilation, electrical current treatment, one or more additional coatings or layers and/or the like. In some embodiments, such a head can be aligned with one or more of the applicator assemblies (e.g., trowels, roller assemblies, etc.) that are configured to splay or otherwise spread resin-impregnated fiber roving onto the target surface. In other embodiments, such heads are offset from the reinforcing system's applicator assemblies. In yet other embodiments, a completely separate system or device can be utilized to perform the desired or required curing procedures. In embodiments where the curing and/or other post-application devices or components are incorporated into a unitary reinforcement system, the process of providing one or more layers of splayed fiber bundle or roving can be conducted faster, more efficiently and/or more effectively, as the curing occurs accurately and in close proximity in time and space to the application of the fiber bundle or roving.

In some arrangements, blasting and/or other scouring steps of a wall or other surface are performed automatically or manually. For example, embodiments that utilize a robotic or other automated system to apply one or more layers of CFRP or other splayed resin-impregnated fiber can be configured to perform the necessary scouring, cleaning or other preparatory work. In other embodiments, a separate device, system or procedure (e.g., either manual) is used to execute one or more of the desired or required prepping steps. In one embodiment, a robotic or other automated system that blasts or otherwise scours a wall (e.g., using high pressure water, sand, etc.) is configured to collect all, most or some of the materials used in the blasting or scouring procedure. In general, this can help speed up the process of reinforcing a pipe or other structure, as less time is required to clean up after the initial scouring steps. The aforementioned blasting, scouring and/or other preparatory steps can be used in connection with any of the embodiments of the reinforcing systems and/or methods disclosed herein.

In addition, one or more curing steps or features (and/or other post-application steps or features) can be incorporated into any of the reinforcing systems or methods disclosed herein, or equivalents thereof. For example, after their application to a wall or other surface, one or more layers of resin-laden, splayed fiber bundle or roving can be selectively subjected to heat treatment, electrical current treatment, ventilated air treatment or other drying procedures, light treatment and/or the like. In some embodiments, light treatment includes the use of infrared (IR), ultraviolet (UV) and/or light of other wavelengths or energy levels. The use of curing or other post-application steps can help to further improve the bond strength between the splayed fiber bundles and the adjacent surfaces to which such bundles are attached. In addition, such post-application procedures can help decrease the curing time, advantageously allowing subsequent layers of fiber bundle and/or other materials (e.g., paint, other finish coats, etc.) to be applied with reduced lag time.

In some embodiments, air or other gases can be delivered through a pipe or adjacent to a surface being treated in order to facilitate curing. Such air or other gases can be provided using one or more fans, blower and/or other fluid transfer devices. However, in other embodiments, splayed fiber bundles are permitted to air dry in an ambient environment without the use of forced air, heat or other curing procedures.

As noted above, once the desired CFRP or other resin-laden fiber layers have been applied to a particular wall or other surface, additional protective, decorative or other coatings or layers can be applied thereto. For example, the fiber reinforcement layers can be selectively coated with paint, finish coats and/or the like. In addition, it may be necessary to cut or tuck portions of the fiber layers, such as, for example, at or near joints or other features of a pipe or other surface being reinforced. The application of additional layers and/or the execution of additional post-application steps (e.g., tucking, cutting, etc.) can be performed manually or automatically (e.g., using a robotic system).

The various embodiments disclosed herein can provide several improvements and advantages over existing systems, devices and methods. For example, placing CFRP roving or bundle directly onto a pipe wall or other surface being treated can help improve the efficiency of a pipe reinforcing procedure. Such embodiments may also be less costly and more reliable. By way of example, the time, money, labor, equipment and other resources used to manufacture, transport, prepare and install separate CFRP sheets onto a surface of a pipe or other structure are substantially greater than they are for the CFRP roving embodiments disclosed herein. For instance, in order to repair a damaged pipe using CFRP sheets, a 12-man crew may be required. In contrast, only a 4-man crew may be necessary to reinforce the same damaged pipe using CFRP roving. Such a reduction in manpower requirements results, at least in part, because the time-consuming and tedious tasks of coating individual CFRP sheets and hand-applying them to a desired surface is eliminated. Further, as discussed in greater detail herein, the direct application of CFRP roving to a wall can advantageously eliminate the need for a tack coat and/or other base layers and/or other preparatory steps (e.g., dehumidifying the pipe).

The direct application of CFRP bundle can also improve the structural characteristics of a reinforced pipe or other structure, as the orientation of the filaments placed on a wall or other surface can be accurately controlled. In contrast, the orientation of the filaments contained within individual CFRP sheets cannot be modified to satisfy specific design criteria or other requirements. Relatedly, the need for longitudinal reinforcement through a pipe or other item is eliminated, because the filaments of the roving can be oriented at one or more angles that provide a desired level of structural integrity in both the circumferential (e.g., hoop) and longitudinal directions.

In addition, the need for dehumidification through a pipe can also be avoided by using one of the embodiments of a reinforcing system or method disclosed herein. For example, when CFRP sheets are used to reinforce a pipe, dehumidification techniques and procedures within or near the pipe are often required before tack coats, primers and/or CFRP sheets are applied.

Furthermore, the various embodiments discussed and illustrated herein can provide several environmental and health benefits. For instance, the amount of epoxy or other resin used with the application of splayed CFRP bundle is generally less than when CFRP sheets are used. Accordingly, the amount of VOCs and other gases or compounds emitted from the resin during the direct application of CFRP roving to a wall can be advantageously reduced. Thus, the exposure of workers to potentially harmful gases and other materials can be advantageously reduced. Moreover, the resin saturator or other container through which raw fiber roving or bundle is routed can be partially or completely covered to further reduce the amount of volatile compounds emitted to the surrounding area and the environment. In addition, the methods described herein generally produce less debris and other solid and/or liquid waste.

In addition, the systems, devices and methods disclosed herein, or equivalents thereof, can advantageously require fewer tools, such as, for example, rollers, buckets, tables and/or the like. Further, it may be easier to transport the various goods required to complete the reinforcing procedures discussed and illustrated herein. For example, the spools, bulk containers or other sources of raw carbon roving and the drums or other containers of resin generally do not require great care or special handling instructions during their delivery to a job site. Moreover, the various devices, components, required tools and/or other equipment required for such systems can be quickly and easily transported, mobilized, set up and taken apart.

According to some embodiments, certain preparatory steps or procedures are performed prior to the application of CFRP roving to an interior wall of a pipe or other surface. For example, the wall or other surface to be treated can be cleaned to remove dirt, dust and other debris. Based on the surface on which the CFRP will be positioned, a top layer of such a surface can be at least partially penetrated or removed. For example, high pressure blasting procedure using water, other liquids or other fluids can be used. In addition, a primer and/or other coatings may also be applied to the surface on which the CFRP will be placed (e.g., using a spray, roller and/or the like). However, in some configurations, a tack coat and/or other binders are not required before the CFRP bundle is applied to the wall or other surface. This can save time and costs, especially when compared to existing methods of installing CFRP sheets on similar surfaces. In addition, one or more top coats can be applied once the CFRP roving has been placed on the pipe wall or other surface. Such top coats can help seal the CFRP, can further enhance the structural integrity of the reinforced section of pipe and/or provide additional benefits, as desired or required.

The systems, apparatuses, devices and/or other articles disclosed herein may be formed through any suitable means. The various methods and techniques described above provide a number of ways to carry out the inventions. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. Additionally, the methods which are described and illustrated herein are not limited to the exact sequence of acts described, nor are they necessarily limited to the practice of all of the acts set forth. Other sequences of events or acts, or less than all of the events, or simultaneous occurrence of the events, may be utilized in practicing the embodiments of the invention.

Although the inventions have been disclosed in the context of certain embodiments and examples, it will be understood by those skilled in the art that the inventions extend beyond the specifically disclosed embodiments to other alternative embodiments and/or uses and obvious modifications and equivalents thereof. Accordingly, it is not intended that the inventions be limited, except as by the appended claims.

What is claimed is:

1. A system for reinforcing a pipe, comprising:
a resin source comprising a resin, said resin source being configured to at least partially impregnate a fiber bundle with resin;
wherein the system is configured to at least partially impregnate a fiber bundle being moved through the system with said resin;
a positioning assembly configured to receive a resin-impregnated fiber bundle, said positioning assembly comprising at least one arm having a distal end;
wherein the system is configured to selectively advance the resin-impregnated fiber bundle relative to the positioning assembly, toward the distal end of the at least one arm;
at least one spreading member extending from the at least one arm, said spreading member configured to spread the resin-impregnated fiber bundle from a first width to a second width and onto an interior wall of the pipe;
wherein the second width of the resin-impregnated fiber bundle is greater than the first width of the resin-impregnated fiber bundle; and
a controller for regulating at least one aspect related to the manner in which the resin-impregnated fiber bundle is advanced relative to the positioning assembly and to the spreading member toward and onto the interior wall of the pipe; and
wherein resin-impregnated fiber bundle splayed by the spreading member is configured to directly adhere to the interior wall of the pipe without the use of tack coats or other intermediate layers.

2. The system of claim 1, wherein the positioning assembly is configured to be grasped and manually manipulated by a user.

3. The system of claim 1, wherein the positioning assembly is configured to be automatically moved relative to the interior wall of the pipe.

4. The system of claim 1, wherein the positioning assembly is configured to selectively rotate about a longitudinal axis of the pipe to circumferentially place resin-impregnated fiber bundle along the interior wall of the pipe.

5. The system of claim 1, wherein the resin source is generally positioned between a raw fiber bundle source and the positioning assembly.

6. The system of claim 5, wherein the resin source comprises at least one advancement assembly to help direct raw fiber bundle from the raw fiber bundle source relative to said resin source to at least partially impregnate said raw fiber bundle with resin.

7. The system of claim 5, wherein the raw fiber bundle source, the resin source and the positioning assembly are positioned on a movable assembly, said movable assembly being configured to automatically or manually move within an interior of the pipe.

8. The system of claim 7, wherein the movable assembly comprises a wheeled cart.

9. The system of claim 1, wherein the system comprises at least one advancement assembly configured to selectively advance the resin-impregnated fiber bundle toward the spreading member.

10. The system of claim 1, wherein the positioning assembly is configured to permit a user to modify an angle at which a resin-impregnated fiber bundle is placed on the interior wall of the pipe.

11. The system of claim 1, wherein the controller is configured to selectively regulate the movement of the positioning assembly about the longitudinal axis of the pipe.

12. The system of claim 1, wherein the controller is configured to control a longitudinal movement of the positioning assembly within the pipe.

13. The system of claim 1, wherein the positioning assembly is secured to a support member, said support member having a first leg and at least a second leg, said first and at least second legs being configured to contact the interior wall of the pipe.

14. The system of claim 15, wherein the support member comprises a wheeled cart or a tripod.

15. The system of claim 1, wherein the fiber bundle is provided on a spool or in a bulk container.

16. The system of claim 1, wherein the fiber bundle comprises nylon, glass, graphite or polyaramid.

17. The system of claim 1, wherein the resin comprises epoxy, polyurethane, acrylic or another polymer.

18. A method of reinforcing a concrete surface using fiber reinforced polymer, comprising:
coating a raw fiber roving with a resin;
directing the resin-coated fiber roving through a positioning assembly of a reinforcing system;
spreading the resin-coated fiber roving that exits a distal end of the positioning assembly onto a concrete surface; and
moving the positioning assembly to place resin-coated fiber roving along a section of the concrete surface;
wherein directing the fiber roving through the positioning assembly comprises operating at least one advancement assembly of the positioning assembly; and
wherein resin-coated fiber roving is configured to directly adhere to the concrete surface without the use of tack coats or other intermediate layers.

19. The method of claim 18, wherein the concrete surface comprises an interior wall of a pipe.

20. The method of claim 18, wherein the concrete surface is part of a wall, beam, column or other structural member.

21. The method of claim 18, further comprising scouring the concrete surface prior to placing resin-coated fiber roving along said concrete surface.

22. The method of claim 18, wherein an angle at which the resin-coated fiber roving is positioned on the concrete surface is adjustable.

23. The method of claim 18, wherein the fiber roving comprises nylon, glass, graphite or polyaramid.

24. The method of claim 18, further comprising curing the resin-coated fiber placed on the concrete surface using light treatment, heat treatment, electrical current treatment or ventilation.

25. A device for structurally reinforcing a member, comprising:
a resin source comprising a resin, said resin source being configured to at least partially impregnate a fiber bundle with resin;
wherein the device is configured to at least partially impregnate a fiber bundle with said resin;
a positioning assembly configured to receive a resin-impregnated fiber bundle;
wherein the device is configured to selectively advance the resin-impregnated fiber bundle toward a distal end of the positioning assembly; and
at least one applicator assembly extending from the positioning assembly, said at least one applicator assembly configured to spread and deposit the resin-impregnated fiber bundle on a surface of the member being reinforced;
wherein the positioning assembly is configured to be automatically or manually moved relative to the surface of the member;
wherein the resin source is generally positioned between a raw fiber bundle source and the positioning assembly;
wherein the device comprises at least one advancement assembly to help direct raw fiber bundle from the raw fiber bundle source relative to said resin source to at least partially impregnate said raw fiber bundle with resin; and
wherein the raw fiber bundle source comprises a spool or a bulk container.
